(19) United States
(12) Patent Application Publication
(10) Pub. No.: US 2015/0302782 A1
(43) Pub. Date: Oct. 22, 2015

(54) SELF POWERED ILLUMINATED BI-DIRECTIONAL STREET SIGN

(71) Applicants: Ferhat Senonal, Independence, KY (US); Robert Brock Coates, New Richmond, OH (US)

(72) Inventors: Ferhat Senonal, Independence, KY (US); Robert Brock Coates, New Richmond, OH (US)

(21) Appl. No.: 14/253,969

(22) Filed: Apr. 16, 2014

(51) Int. Cl. G09F 13/04; H02J 7/00; H02J 7/35; G09F 13/22; G09F 13/06

(52) U.S. Cl. CPC G09F 13/0413; G09F 13/22; G09F 13/06; H02J 7/35; H02J 7/0052; H02J 7/007

(57) ABSTRACT

A street sign assembly is provided wherein the panels are illuminated. Two street signs, substantially perpendicularly to one another mounted on a pole near an intersection of two streets, are backlit on both sides to make them visible readable at night. Low power consumption light emitting diodes (LEDs) are used to illuminate the signs and are mounted internal to the sign housing such that the street name is backlit from within the housing, making it more readable from a distance at night. The LEDs are mounted between the two opposed faces of a housing so that their light is used to illuminate both faces. Translucent opposed frosted plates are positioned within the housing to reflect the LED lights and to prevent the mirror images on the two opposed faces from being visible from the other side. The power for the LEDs is provided by rechargeable DC batteries. A solar panel and a DC generator coupled to a wind turbine are installed on the post and are wired to provide charge current to the DC batteries. An electrical charge circuit is provided to control the selection of the charge current and the connection of the battery pack to drive the load.

### FIELD OF THE INVENTION

The present invention relates to a bi-directional illuminated street sign assembly that is self powered. The present invention particularly relates to an illuminated street sign that uses solar or wind power to provide the energy necessary for illumination.

### BACKGROUND OF THE INVENTION

Street signs bearing the name of the road, street, avenue or thoroughfare have long been the necessary aid of travelers seeking a destination with which they are unfamiliar. Even in the age of online navigation tools, signs denoting the names of streets are a necessary resource for people and things to get where they are going, particularly for anyone giving, receiving or following directions to a destination.

Street signs have long had a major flaw in that they are not illuminated, making their use at night very limited. A driver attempting to follow directions by following or checking the street he is on will either find it impossible or will have such difficulty reading unlit street signs that he will be forced to get very close to the street sign and, in many instances, exit the vehicle, to be able to read the street sign. While it has become common that many streets, such as major highways and main arteries that have red/yellow/green lighted signals have also added illumination that shines upon a sign indicating the name of the street, the corner intersection type street sign has not been illuminated. That is, while street signs mounted high above the street of major roadways and thoroughfares are often hung from the same supporting structure as traffic lights and lighted by spotlights that are powered by the same electrical supply that is already available and present for the traffic lights, that luxury is not available for the corner intersection type street signs mounted on posts. For every community in the United States that has un-illuminated corner intersection street signs, the cost to run an electric service feed to the signs would be enormous, particularly if the electric service was run underground throughout the subdivision.

It has long been the bane of the traveler trying to find a location at night that street signs on small sidestreets and in suburban neighborhoods are not lit, making the already difficult task of following directions given by someone else even more frustrating. Illumination of street signs that allows drivers to ensure or confirm that they are, in fact, on the proper street, would save many travelers from having to pull up right in front of the sign and get out to take a closer look, an advantage that becomes particularly acute in times of inclement weather.

Interestingly, this problem of poor night time visibility of addresses also exists with respect to house numbers on mailboxes, or on the curb or on the house itself, but there have been a number of solutions for illuminating such house numbers to address that problem. For example, U.S. Pat. No. 6,799,716 provides a system including a solar powered mailbox wherein a solar array harnesses energy from the sunlight and shines a spotlight down onto a house number to illuminate an identifying feature that previously would have been virtually useless after dark. It is an act of near desperation for a driver in a vehicle to exit a vehicle or get close enough to read an un-illuminated house number when trying to locate an address. U.S. Pat. Nos. 6,131,321 and 6,994,448 also disclose devices and systems for illuminating house numbers to make them more usable for the traveler after dark, but each of those devices and systems have disadvantages when considering their possible application to bi-directional street signs mounted on posts, generally positioned on corners where two streets intersect.

Pole mounted street signs, such as those found at corner intersections, generally have a two sided sign for each of the two intersecting streets so that drivers approaching from either direction will be able to read the street name of both intersecting streets. Thus there are effectively four street name signs on each pole that need illumination. The street name signs are generally elevated, 7 to 10 feet above the ground, so any spotlight illumination of the street signs from ground level is very difficult and impractical. If solar powered spotlights were to be used to illuminate street signs from ground level, for example, they would either need to be very strong spotlights, using a lot of electric power and, if solar energy was the source of the electrical energy, a very large solar array would be required. If the spotlights are mounted high on the pole, additional structure must be added to the pole that supports the spotlights if they are to be suspended to shine down on the street signs and the structure must not interfere with the ability to read the sign from the ground.

The solutions for illuminating house numbers, and other signage similar to the street signs with which we are here concerned, all have disadvantages when applied to the traditional pole mounted corner intersection street signs. Any solution that uses alternating current electricity has the major disadvantage of the cost of running power lines to every street corner. It is impractical to expect electric service to be available near a corner intersection where the post mounted street signs are found. As mentioned above, the cost to run electric service to illuminate street signs is prohibitive, whether it would be run overhead or underground, and it also would create a new recurring utility expense if electricity is consumed to light the street signs.

To supply power to corner intersection street signs, clearly the best alternative is the use of rechargeable power supplies, batteries, that store electrical energy at the site and do not require any wiring installation. The power supplies will require energy to be re-charged, however, and solar energy is a good source of charging current. Some other stand alone signage, including house number lighting systems, use solar energy in this manner. However, even those prior art solutions that use solar energy to supply a power storage device such as a rechargeable battery are disadvantageous because of the quantity of illumination required. That is, the amount of and arrangement of illumination to shine a spotlight upon three or four numbers to make them visible and readable is far different than that required to light up the names of four elevated generally perpendicularly positioned street signs. The size of the solar array to power illumination is far different than the proposed solutions for illuminating house numbers. If the solar panel is mounted near or on the light structure or pole, the size and weight of the solar panel may become prohibitive.

In addition, any system that is completely reliant upon solar energy to provide the necessary electrical energy to keep batteries charged will suffer from time to time when sunlight is not intense or plentiful enough. In a preferred embodiment of the present invention a second energy capture mechanism is provided in the form of a wind turbine that will generate electric power to charge the batteries powering the illumination, in the event there is inadequate solar energy.

The present invention, as set forth in more detail herein, solves the problem of illuminating corner intersection street signs by solving problems not addressed by similar prior art solutions. Illumination is provided that does not require electric or other outside utility to power it, spotlights requiring a lot of electrical energy are not used, and the lighting provides enough illumination to light up four street signs by using dual energy sources, including a solar array that is itself mounted to the pole, and efficient illumination techniques and devices to make the energy sources and battery storage sufficient. The solar energy is securely mounted to the top of the pole to capture the maximum amount of sunlight while also not interfering or obstructing the street signs.

The present invention applies a number of improving technologies in a new and unobvious way to provide the innovative system for illuminating corner intersection, pole mounted street signs. Specifically, the applicant has applied advances in the simultaneous harnessing of solar energy and wind energy, including the necessary control circuit required, as well as the use of long life re-chargeable batteries and energy efficient light emitting diodes (LEDs) to provide the illumination required.

The present invention has solved the numerous disadvantages of the prior art by providing a system wherein the street signs are back lit, rather than lit with an external spotlight. This is a significant evolutionary step insofar as the structure supporting a backlit street sign must be adequately strong to withstand weather and wind, as well as be generally impervious to vandalism and horseplay, such as teenagers hanging from the street signs. It must also be provided with internal mechanical provisions for protecting and supporting the signage, the LED lighting, the control circuitry and battery, and supporting the solar array, all while providing backlighting for two sets of two opposed street signs and not interfering or obstructing the view of the street signs. Heretofore the problem of providing a backlit street sign, with translucent panels, which is also adequately strong to withstand predictable hanging from the sign by teenagers and vandals, has not been addressed. In a preferred embodiment of the present invention, a dual sided, front and back housing is provided for each of the two pole mounted street signs, with highly efficient LEDs enclosed in the housing that provide adequate illumination to light up both sides of the signs. The same LEDs light up both sides, the light glowing through opposed translucent frosted panels that allow the same light source LEDs to provide illumination to both sides while eliminating the visual interference that would result if two opposed mirror images of the alphanumeric characters were juxtaposed against each other without anything between them. That is, the street names on both sides of the housing are readable, even though they are illuminated by the same light, because the opposed frosted translucent panels prevent the visual interference that would otherwise result By utilizing the same LEDs to light up both sides, a smaller number of lights and batteries is required, the circuitry is simplified and no internal structure dividing the space between the two opposed signs is necessary to prevent visual interference.

In another embodiment of the present invention, electroluminescent panels are utilized on the opposed sides the street signs, sandwiched between sheets of plexiglass. The electroluminescent panels are powered by the battery pack, which is re-charged with solar energy. A smaller solar array is necessary to provide a smaller charge current to the batteries. In addition, if a wind turbine energy source is applied, it will likewise be smaller because of the need for less charge current.

The present invention also addresses mechanical and structural limitations posed by the desire to illuminate pole mounted street signs. Specifically, the present invention provides a hollow pole accommodating the dual sided dual directional street sign housings, with specific provisions for running control wiring to the LED or electroluminescent lighting in the housings from a central control chamber. In the preferred embodiment of the present invention, as forth herein, the battery and control circuitry is positioned and accessible within the hollow pole, resting upon extensions of the housing mounting bolts near the top of the cavity of the hollow pole.

There is thus identified a need for a system for illuminating pole mounted street signs that provides for self powering of adequate illumination to light four street signs arranged generally as two perpendicularly positioned opposed signs. To be effective and efficient, the street signs are either back lit, utilizing efficient LED's and the same light sources to illuminate both front and back of a street sign housing, or comprise electroluminescence panels in a structural framework that will withstand weather, wind and vandalism, all while preventing visual interference between the front and back. The system must be maintainable and have low energy consumption requirements. It may also be provided with dual energy harnessing capabilities to overcome the event that solar energy is inadequate to provide the necessary charge current for the batteries.

### OBJECTS OF THE INVENTION

It is an object of the present invention to provide a self powered illuminated bi-directional street sign that does not require any outside energy source for illumination.

It is another object of the present invention to provide a self powered illuminated bi-directional street sign that utilizes dual sources of energy harnessing to provide charge current for a self contained energy storage device comprising batteries.

It is yet another object of the present invention to provide a self powered illuminated bi-directional street sign that uses the same light source to light both sides of a dual sided housing while preventing visual interference between the dual sides.

It is another object of the present invention to provide a self powered illuminated bi-directional street sign that does not require any outside energy source for illumination that utilizes efficient illumination devices comprising LED lighting to minimize electric power consumption and, thereby, minimize the number of batteries and the size of the solar array required to charge the batteries.

It is yet another object of the present invention to provide a self powered illuminated bi-directional street sign that does not require any outside energy source for illumination wherein both sides of a bi-directional street sign housing are backlit by the same light source.

It is another object of the present invention to provide a self powered illuminated bi-directional street sign wherein electroluminescent panels are provided on opposed sides sandwiched between protective layers of plexiglass.

It is yet another object of the present invention to provide a self powered illuminated bi-directional street sign that does not require any outside energy source for illumination wherein a solar array is mounted to the top of the post on which the street signs are mounted to provide a protective canopy as well as being optimally placed to receive sunlight.

It is yet another object of the present invention to provide a self powered illuminated bi-directional street sign that does not require any outside energy source for illumination wherein electrical controls coordinate use of a dynamic system shifting between charging from a solar array to charging from a wind turbine to powering up the batteries to provide the current to drive the LEDs or electroluminescent panels to illuminate the street signs.

### SUMMARY OF THE INVENTION

The present invention comprises a street sign assembly comprising a mounting post and at least one dual sided housing bearing a street name secured to said post. A means for illuminating the dual sided housing is also provided, along with an energy storage device located within the street sign assembly. The energy storage device provides energy to the means for illuminating. An energy harnessing device provides the charge current to the energy storage device.

The street sign assembly in the most preferred embodiment comprises two housings secured to said post. These two housings each comprise two opposed illuminated faces and are structurally resilient to weather, wind and vandalism. In the most preferred embodiment of the present invention, the means for illuminating comprises internal illumination means positioned within each of the two housings. To avoid visual interference the two housings have means for preventing visual interference between their opposed faces.

The two housings specifically have a pair of opposed translucent panels with opaque coatings etched or carved such that only the desired indicia will be illuminated from behind on the sign.

In the most preferred embodiment of the present invention the means for illuminating further comprises light sources positioned within the housings and between the opposed frosted translucent panels wherein the same light sources illuminate both opposed faces of the housing.

The energy storage device for the present invention comprises a rechargeable electrical storage battery mounted within the pole assembly and wired to both of the housings. The battery is mounted in a weather proof enclosure in the pole. The illuminated street sign is also provided with an electrical charging circuit controlling charge current to the battery. In conjunction with the control circuit, a means for harnessing energy is provided comprising at least one solar panel collecting solar energy and providing electrical charge current to the electrical charging circuit. At least one solar panel is positioned on top of said post in the most preferred embodiment of the present invention.

Further, the means for harnessing comprises at least one wind turbine in rotary motion collecting wind energy and means for generating electrical charging current to the electrical charging circuit from the rotary motion of the wind turbine. Further, the means for harnessing further comprises at least one wind turbine in rotary motion collecting wind energy wherein the electrical charging circuit has a means for selecting between the solar and wind turbine.

### BRIEF DESCRIPTION OF THE DRAWINGS

FIG. 1 is a perspective view of the illuminated street sign of the present invention reflecting the relative components of positions of the solar array, illuminated street sign housings and features of the pole directed to receiving the bi-directional street signs.

FIG. 2 is a perspective view of a housing constructed from an extruded frame members and opposed frosted translucent panels.

FIG. 3 is a side view of the illuminated street sign of the present invention reflecting the relative components of positions of the solar array, wind turbine, illuminated street sign housings and features of the pole directed to receiving the bi-directional street signs.

FIG. 4 is a perspective view of the mounting pole of the illuminated street sign of the present invention illustrating the provisions for securing the dual sided street sign housings to the pole using bolts with extensions into the pole cavity.

FIG. 5 is a perspective view of a dual sided street sign of the present invention illustrating the juxtaposed mirror image on the dual sides of the housing.

FIG. 6 is a front view of a dual sided street sign housing of the present invention depicting the relative location of the top mounted LED light sources within the housing to back light the translucent frosted panels in both directions without visual interference.

FIG. 7 is a top view of a dual sided street sign housing of the present invention depicting the relative location of the top mounted LED light sources mounted on the top shelf mounted light board.

FIG. 8 is a control circuit for the illuminated street sign of the present invention operable in three modes, as a wind turbine charging circuit for the battery pack, as a solar array charging circuit for the battery pack, and as a battery supply to a bank of LED lights through the necessary resistor to extend battery life.

FIG. 9 is a detailed depiction of the structural frame of the housing depicting an extruded housing having opposed slots to receive translucent panels or a plexiglass/electroluminescent panel/plexiglass sandwich, a shelf to retain the necessary light board, and threaded sleeves to secure the end and side panels together.

FIG. 10 is a detailed depiction of the bolt connected housing to the pole depicting the supporting structure for the battery and control elements.

FIG. 11 is a detailed perspective view of the bolt connected housing to the pole depicting the supporting structure for the battery and control elements.

FIG. 12 is a detailed perspective view of the housing of the present invention depicting the extruded aluminum member and the interconnections between the top and bottom members and the end plates.

FIG. 12a is a front view of the housing end plate.

FIG. 12b is an endview of the housing with the endplate removed.

FIG. 13 is a schematic representation of an illumination sandwich comprising an outward facing sheet of transparent plexiglass, electroluminescent panel and an inward facing sheet of plexiglass.

FIG. 14 is a cross section of the extruded aluminum bar of the present invention.

### DETAILED DESCRIPTION OF THE INVENTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention and is made merely for the purpose of providing a full and enabling disclosure of the present protection. The detailed disclosure herein of one or more embodiments is not intended, nor is to be constructed, to limit the scope of patent protection afforded the present invention, which scope is to be defined by the claims and the equivalents thereof. It is not intended that the scope of the patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods are not limited to being carried out in any particular sequence or order, absent an indication otherwise. Indeed, the steps in such process or methods generally may be carried out in various different sequences and orders while still falling within the scope of the present invention. Accordingly, it is intended that the scope of the patent protection afforded the present invention is to be defined by the appended claims rather than the description set forth herein.

Additionally, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to a “picnic basket having a single apple” describes “a picnic basket having only one apple.”

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese and crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

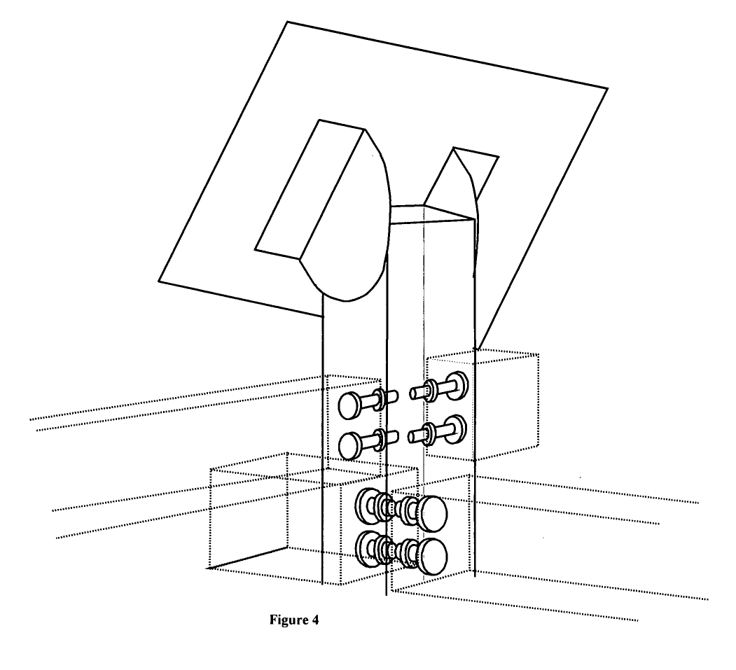

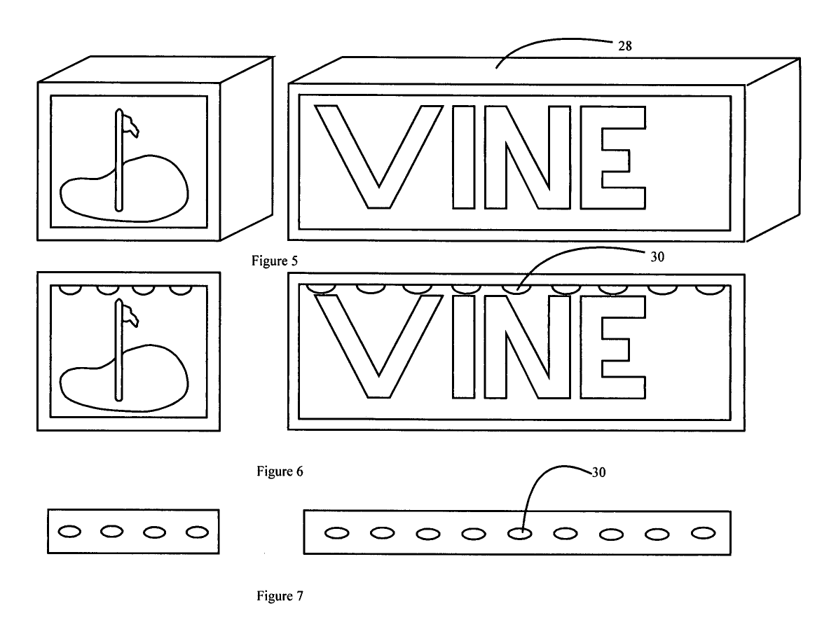

The present invention, as shown in the drawings utilizing reference numbers, addresses the limitations and disadvantages of the prior art. Specifically, a street sign assembly 10 is provided wherein two street signs 12, 14 are mounted on a vertical mounting pole 16. Each of the street signs 12, 14 depicted are elongated housings 18, 20 that bear a street name 22, 24 thereon. The housings 18, 20 have dual opposed faces 26, 28, as depicted in FIG. 5. Within the housings 18, 20 are positioned a means for illuminating the street names 22, 24. In a preferred embodiment of the present invention, the means of illumination comprises a sheet 30 of light emitting diodes (LEDs) mounted interiorly near the top of the housings 18, 20 that glow downwardly to provide a light source behind the translucent inscribed panels 26, 28 (see FIGS. 6 and 7). In operation, the LEDs 30 illuminate the interior of the housings 18, 20 and thereby appear as visible light through the translucent portion of the faces 26, 28 comprising the street names. Alternatively, an illumination sandwich 99 is provided in place of the translucent panels 26, 28 comprising a transparent outer sheet of plexiglass 100, an electroluminescent panel 102, and an opaque sheet of plexiglass 108. This illumination sandwich 99, with the electroluminescent surface 102 provided with the street name lit up, is inserted into the housings 18, 20 instead of the translucent panels 22, 24 and LED sheet 30.

The translucent faces 26, 28 or illumination sandwich 99 are secured within the housings in slots 30, 32. The housings 18, 20 of the present invention are designed to be structurally sound, able to withstand weather, wind and vandalism, by providing extruded aluminum members formed with opposed brackets 33, 35 having opposed slots 30, 32 to receive translucent panels 26, 28. They also form a light shelf 37 to support downwardly glowing LED panel 30 and have threaded sleeves 39 to receive and secure connecting hardware. Assembly of the housings 18, 20 comprises cutting two lengths, an upper plate 120 and a lower plate 122, from the extruded aluminum bar 110 having a cross section (see FIG. 14) with opposed 45 degree angle cuts 124. End plates 126, 128 are also cut from the extruded aluminum bar 110 and have clearance holes 130 drilled therein so that the end plates 128 are secured to the upper plate 120 and lower plate 122 with screws 132.

Assembly of the housings is particularly advantageous to this bi-directional backlit sign assembly because the novel design of the extruded aluminum bar 110 serves many purposes simultaneously. Cutting the upper plate 120 and lower plate 122 with 45 degree angle cuts, and then cutting an end piece 126, also with a 45 degree cut, allows a three sided housing construction when end plate 126 is drilled with clearance holes 130 that allow screws 132 to be threaded into sleeves 39 to secure the end plate 126 to the upper plate 120 and lower plate 122.

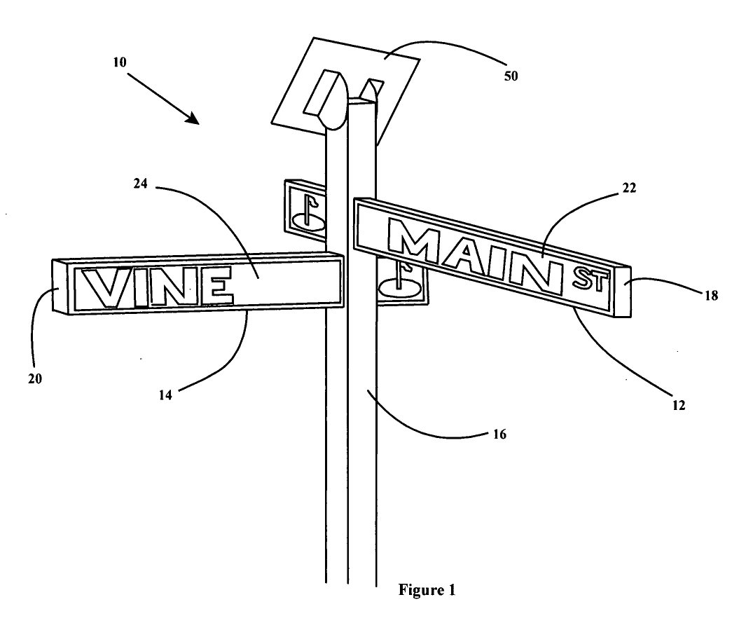

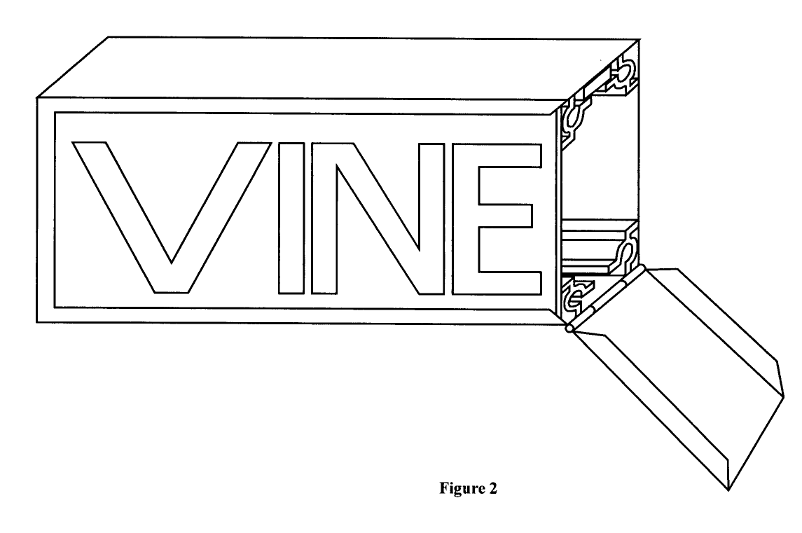

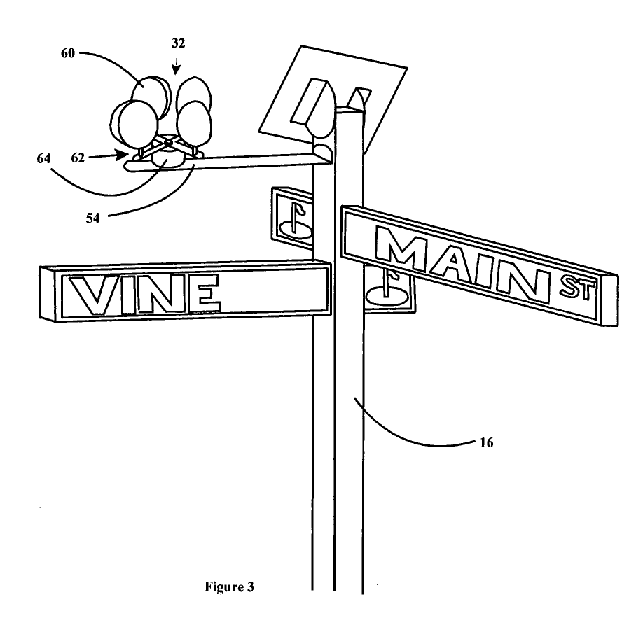

The present invention is significant insofar as the power for the illuminating LEDs is provided by a rechargeable DC battery pack 48, and the DC battery pack charge current is provided by a solar array panel 50 mounted on top of the post 16 and a wind turbine 52 mounted on a plate 54 extending out from the post 16. The wind turbine comprises a plurality of wind catching cups 60 that cause rotary frame 62 to rotate as shown (FIG. 1), thereby causing the shaft extending from DC generator 64 to rotate, producing electrical energy output in the form of charge current to the to the battery pack 48.

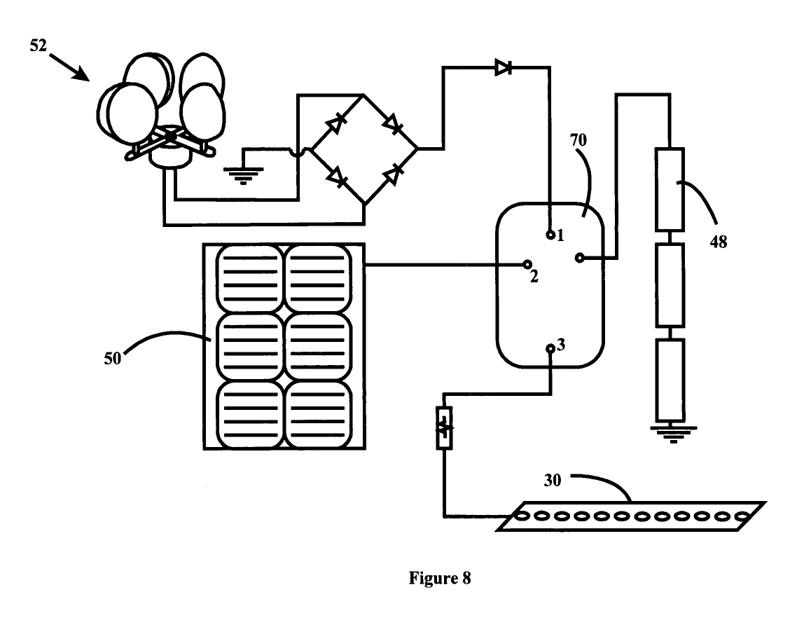

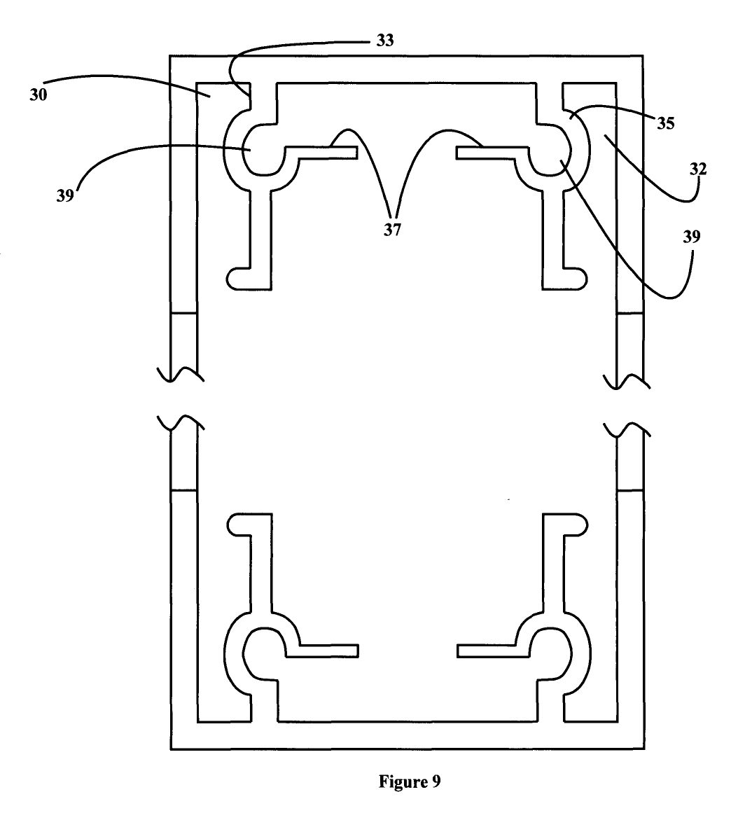

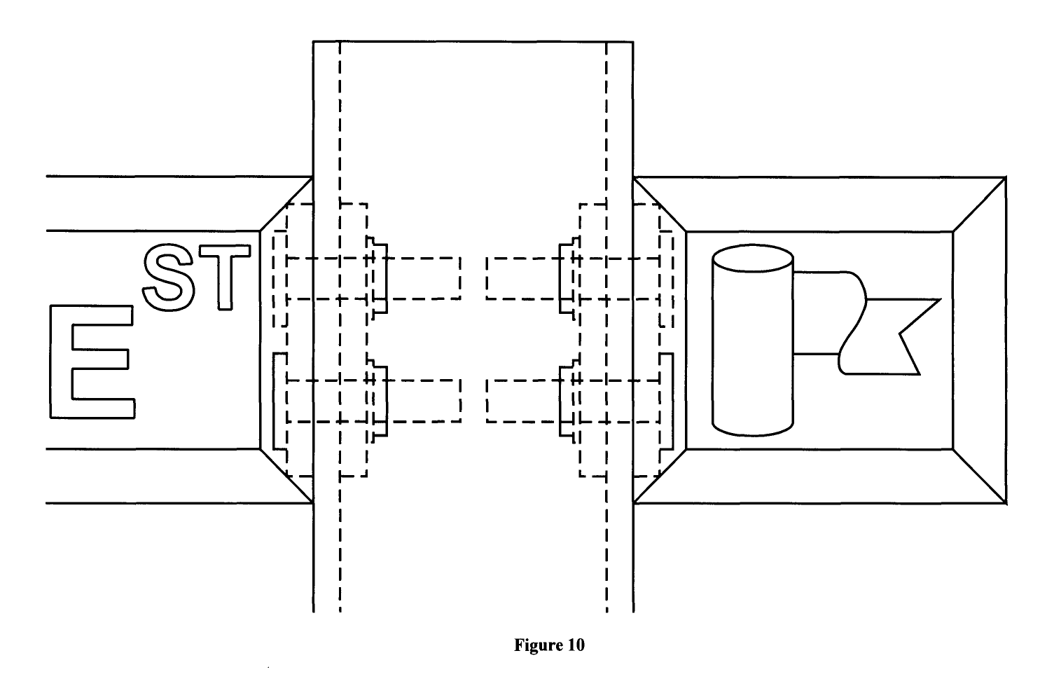

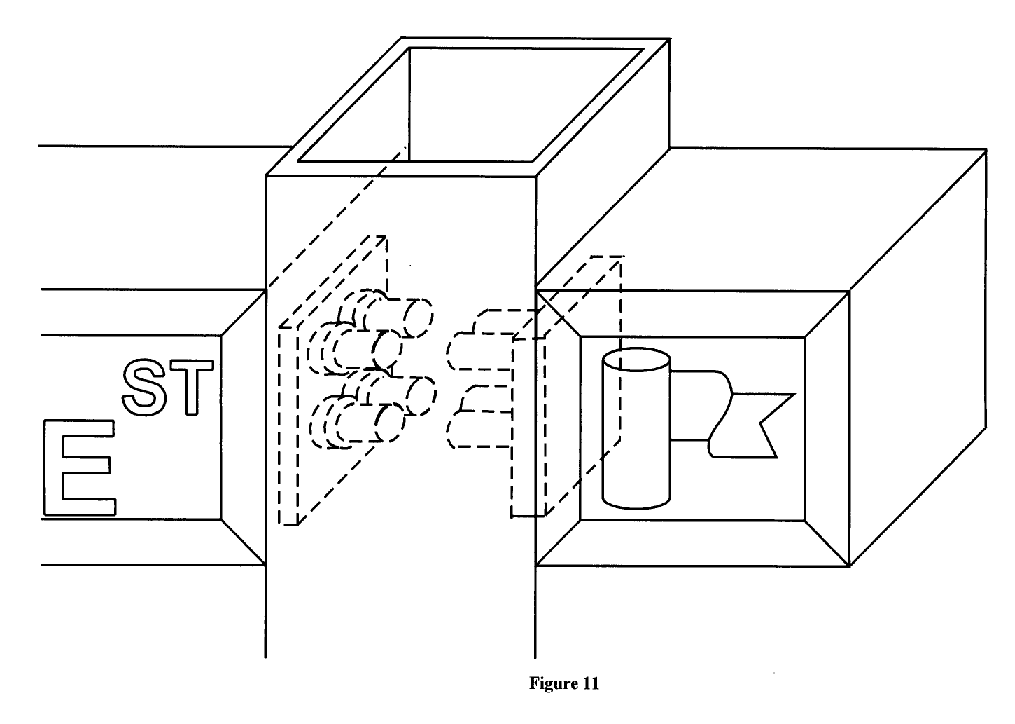

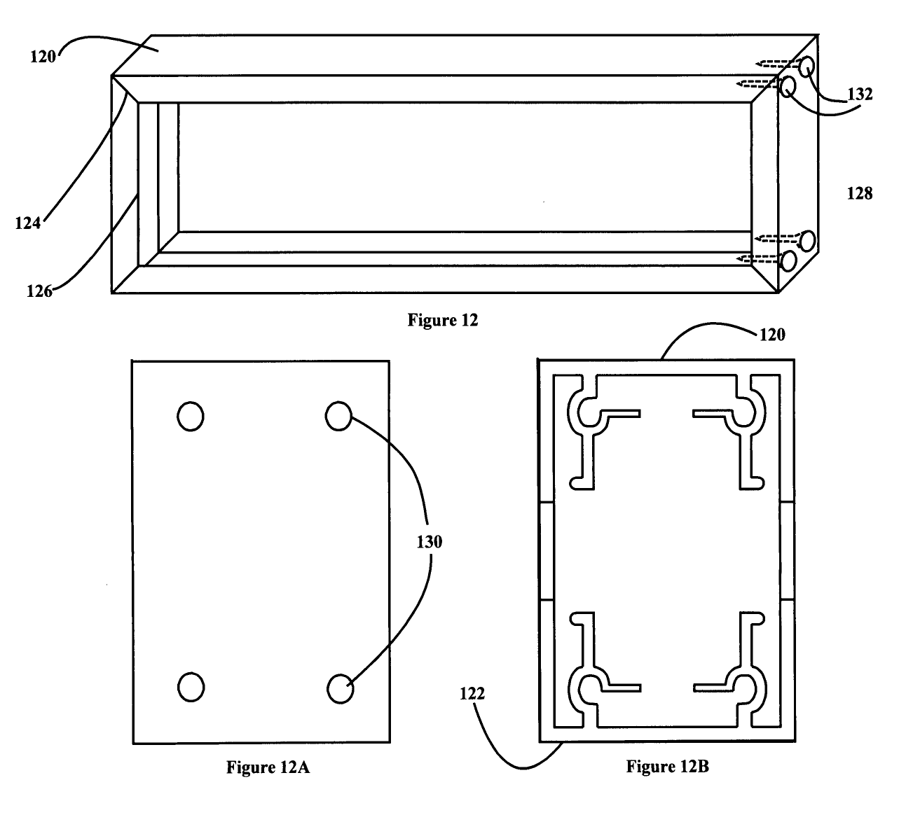

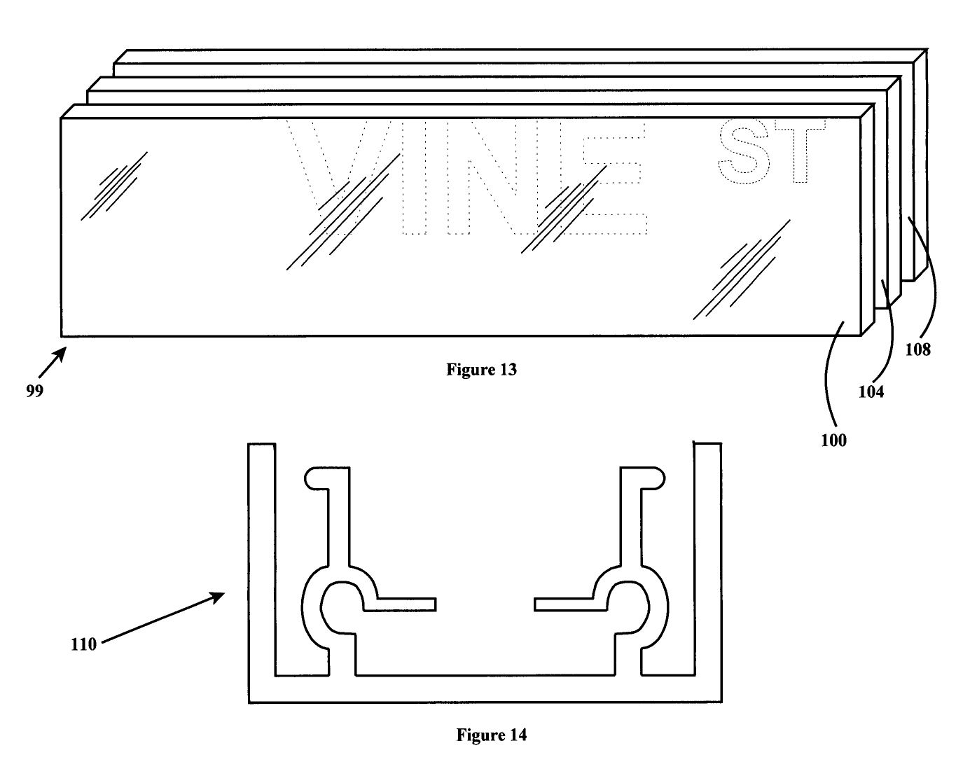

The present invention is characterized by its use of a smart selector 70 which receives input current from the wind turbine driven DC generator 64 and solar array 50, and the smart selector 70 chooses based upon the nature and stability of each current which to couple to the battery pack 48 to achieve the most efficient and most complete charge. When the battery pack 48 is fully charged, and the smart selector detects condition 3 requiring illumination, the circuit is completed by the 3 position switch to cause the battery supply 48 to supply current to the LEDs 30 (see FIG. 8).

In the most preferred embodiment of the present invention, a 100 ohm resistor is installed in line with the LEDs 30 to clamp the current through the LEDs, thereby extending the time of illumination and the life of the battery pack 48 and LEDs 30.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described in order to best illustrate the principles of the invention and its practical application to thereby enable one of ordinary skill in the art to best utilize the invention in various embodiments and with various modifications as are suited to the particular use contemplated. It is intended that the scope of the invention be defined by the claims appended hereto

I claim:

1. A street sign assembly comprising:
a mounting post;
at least one dual sided housing having a street name panel on both sides, said housing secured to said post;
means for illuminating said street name panel on said dual sided housing;
an energy storage device located within said street sign assembly providing energy to said means for illuminating; and
at least one energy harnessing device in electrical communication with said energy storage device.

2. The street sign assembly of claim 1 wherein said street name panel on both sides of said at least one dual sided housing comprises opposed street name panels and means for preventing visual interference between said opposed street name panels.

3. The street sign assembly of claim 2 wherein said means for preventing visual interference comprises said street name panels on both sides of said dual sided housing comprising two opposed translucent illuminated faces.

4. The street sign assembly of claim 3 wherein said means for illuminating comprises internal illumination means positioned within each of said two housings between said translucent faces.

5. The street sign assembly of claim 2 wherein said means for preventing visual interference comprises electroluminescent panels.

6. The street sign assembly of claim 4 wherein said two street name panels comprise frosted translucent plates having opaque etchings or carvings.

7. The street sign assembly of claim 5 wherein said means for preventing visual interference further comprise sheets of protective plexiglass in front of and behind said electroluminescent panels.

8. The street sign assembly of claim 2 wherein said energy storage device comprises a rechargeable electrical storage battery mounted within said assembly and wired to both of said housings.

9. The street sign assembly of claim 8 wherein said battery is mounted in said mounting post in a position of accessibility from the top of said post.

10. The street sign assembly of claim 9 further comprising an electrical charging circuit controlling charge current to said battery.

11. The street sign assembly of claim 10 wherein said means for harnessing comprises at least one solar panel collecting solar energy and providing electrical charge current to said electrical charging circuit.

12. The street sign assembly of claim 11 wherein said at least one solar panel is positioned on top of said post.

13. The street sign assembly of claim 12 wherein said means for harnessing comprises at least one wind turbine in rotary motion collecting wind energy and means for generating electrical charging current to said electrical charging circuit from said rotary motion of said at least one wind turbine.

14. The street sign assembly of claim 13 wherein said means for harnessing further comprises at least one wind turbine in rotary motion collecting wind energy wherein said electrical charging circuit comprises means for selecting between said solar and said wind turbine.
